(19) United States
(12) Patent Application Publication
(10) Pub. No.: US 2026/0239075 A1
(43) Pub. Date: Aug. 13, 2026

(54) QOS MEASUREMENT FOR MULTIPLE UES

(71) Applicant: Telefonaktiebolaget LM Ericsson (publ), Stockholm (SE)

(72) Inventor: Wenliang XU, Shanghai (CN)

(21) Appl. No.: 19/156,359

(22) PCT Filed: Jan. 29, 2024
(86) PCT No.: PCT/CN2024/074383

§ 371 Date: Aug. 13, 2025

(30) Foreign Application Priority Data
Feb. 17, 2023 (WO) PCT/CN2023/076771

(51) Int. Cl. H04W 24/10

(52) U.S. Cl. CPC H04W 24/10

(57) ABSTRACT

The embodiments herein relate to QoS measurement for multiple UEs. In some embodiments, there proposes a method (500) performed by a first network function (111, 700) implementing a Vertical Application Layer (VAL) server. In an embodiment, the method may comprise the step of transmitting (S501), to a second network function (212, 800) implementing a Service Enabler Architecture Layer (SEAL) Data Delivery (DD) server, a subscription message for requesting a reporting of a transmission quality measurement for one or more VAL User Equipments (UE) (201). The subscription message includes a first parameter indicating a group of VAL UEs (201), or all VAL UEs (201) as measurement target VAL UEs. In an embodiment, the method may further comprise the step of receiving (S502), from the second network function (212, 800), a notification message for providing the reporting of the transmission quality measurement. With the embodiments herein, the QoS measurement in SEALDD layer may be improved to support multiple VAL UEs in one subscription.

### CROSS REFERENCE TO RELATED APPLICATION

This application claims priority of PCT Application Serial Number PCT/CN2023/076771 filed on Feb. 17, 2023 with title of “QOS MEASUREMENT FOR MULTIPLE UES”, the entire contents of which are incorporated herein by reference.

### TECHNICAL FIELD

The embodiments herein relate generally to the field of communication, and more particularly, the embodiments herein relate to Quality of Service (QoS) measurement for multiple User Equipments (UEs).

### BACKGROUND

SEAL (Service Enablement Architecture Layer for Verticals) has been introduced to support vertical applications (e.g. vehicle to everything (V2X) applications) since 3GPP Release 16. 3GPP TS 23.434 specifies application plane and signaling plane entities for application-enabling services (e.g. group management, configuration management, location management, identity/key management, network resource management) that can be reused across vertical applications. SEAL also specifies the northbound Application Programming Interfaces (APIs) for its individual services to enable flexible integration with vertical applications.

FIG. 1 is a schematic block diagram showing generic on-network functional model 100 of SEAL. As shown in FIG. 1, in the Vertical Application Layer (VAL), a VAL client 121 may communicate with a VAL server 111 over VAL-UU reference point. The VAL-UU may support both unicast and multicast delivery modes.

The SEAL functional entities on the UE 101 and the server are grouped into SEAL client(s) 122 and SEAL server(s) 112 respectively. The SEAL may comprise a common set of services (e.g. group management, location management) and reference points. The SEAL offers its services to the VAL.

The SEAL client(s) 122 may communicate with the SEAL server(s) 112 over the SEAL-UU reference points. The SEAL-UU may support both unicast and multicast delivery modes. The SEAL client(s) 122 may provide the service enabler layer support functions to the VAL client(s) 121 over SEAL-C reference points. The VAL server(s) Ill may communicate with the SEAL server(s) 112 over the SEAL-S reference points. The SEAL server(s) 112 may communicate with the underlying 3GPP network system 102 using the respective 3GPP interfaces specified by the 3GPP network system 102.

### Data Delivery (DD)

One of the capabilities that SEAL provides is Data Delivery (DD).

FIG. 2 is a schematic block diagram showing the on-network functional model of SEAL for DD, which is architecture 200 for SEAL Data Delivery service.

For uplink (UL) traffic, the VAL client 121 may send application data traffic to a SEALDD client 222 for SEALDD service over SEALDD-C. After data plane packet processing by the SEALDD client 222, the application data traffic may be converted to SEALDD data traffic and transferred to a SEALDD server 212 over SEALDD-UU. The SEALDD server 212 may restore the application data traffic and send it to the VAL server 111 over SEALDD-S.

For downlink (DL) traffic, the VAL server 111 may send application data traffic to the SEALDD server 212 for SEALDD service over SEALDD-S. After data plane packet processing by the SEALDD server 212, the application data traffic may be converted to SEALDD data traffic and transferred to the SEALDD client 222 over SEALDD-UU. The SEALDD client 222 may restore the application data traffic and send it to the VAL client 121 over SEALDD-C.

Optionally, VAL deployments may choose to route application signaling traffic and application data traffic for some or all functions it offers using SEALDD service and FIG. 3 illustrates the architecture for achieving this. In this case the VAL client 121 and the VAL server 111 may choose not to maintain application connection by themselves and transfer all the application traffic over SEALDD connections for those functions.

Note that the SEALDD capabilities may be provided as APIs to the VAL layer, it is up to the VAL layer to decide which traffic to be transferred (e.g. application signaling, application data).

FIG. 3 is a schematic block diagram showing example architecture for SEAL application traffic transfer. The SEALDD client 222 may interact with the SEALDD server 212 to establish application layer data transport path. Through this path, the SEALDD server 212 and the SEALDD client 222 may provide data transport service capabilities such as data plane packet processing (e.g. packet duplication, elimination or transport coordination), data forwarding, data caching, background data transfer, etc. to support the VAL server 111 and the VAL client 121.

The data transport service capabilities provided by the SEALDD client 222 and the SEALDD server 212 may be enhanced by carrying out the data transmission quality measurement. Currently, the SEALDD data transmission quality measurement only supports a single UE.

### SUMMARY

The embodiments herein propose methods, network functions, computer readable medium and computer program product for enabling QoS measurement for multiple VAL UEs.

In some embodiments, there proposes a method performed by a first network function implementing a VAL server. The method may comprise the step of transmitting, to a second network function implementing a SEALDD server, a subscription message for requesting a reporting of a transmission quality measurement for one or more VAL UEs. The subscription message may include a first parameter indicating a group of VAL UEs, or all VAL UEs as measurement target VAL UEs, and optionally, all the VAL UEs might have established SEALDD connections with the second network function. The method may further comprise the step of receiving, from the second network function, a notification message for providing the reporting of the transmission quality measurement.

In an embodiment, the first parameter may comprise a group identifier (ID) of the group of VAL UEs, or an indication to indicate all the VAL UEs.

In an embodiment, the group of VAL UEs may include a plurality of VAL UEs sharing the same VAL service and/or being located in the same geographic area.

In an embodiment, the subscription message may further include a second parameter indicating a reporting periodicity if the reporting is set to a periodic reporting.

In an embodiment, the subscription message may further include a third parameter indicating a reporting granularity.

In an embodiment, the reporting granularity may indicate whether the requested reporting is for a specific VAL UE, an individual VAL UE of multiple VAL UEs, the group of VAL UEs, or all the VAL UEs.

In an embodiment, the subscription message may further include a fourth parameter indicating one or more measurement conditions for the transmission quality measurement.

In an embodiment, the one or more measurement conditions may include one or more spatial conditions and/or one or more temporal conditions.

In an embodiment, if the one or more conditions are not satisfied, the SEALDD server may stop or suspend the transmission quality measurement.

In an embodiment, the notification message may further include a fifth parameter indicating one or more VAL UEs for which transmission quality are measured and/or reporting of the transmission quality measurements are provided based on the third parameter.

In an embodiment, if the third parameter is set to a specific VAL UE or an individual VAL UE of multiple VAL UEs, the transmission quality measurement for the one or more VAL UEs may be a transmission quality measurement value for the specific VAL UE or the individual VAL UE.

In an embodiment, if the third parameter is set to multiple VAL UEs, the transmission quality measurement for the one or more VAL UEs may be an aggregation of transmission quality measurement values for the group of VAL UEs or all the VAL UEs.

In an embodiment, the notification message may further include a sixth parameter indicating an average measurement value of a plurality of transmission quality measurement values for the group of VAL UEs or all the VAL UEs.

In an embodiment, the subscription message may be a SEALDD enabled data transmission quality measurement subscription request.

In an embodiment, the notification message may be a SEALDD enabled data transmission quality measurement notification.

In an embodiment, the transmission quality measurement may be a measurement on any one of latency, bitrate, or packet loss rate.

In some embodiments, there proposes a method performed by a second network function implementing a SEALDD server. The method may comprise the step of receiving, from a first network function implementing a VAL server, a subscription message for requesting a reporting of a transmission quality measurement for one or more VAL UEs. The subscription message may include a first parameter indicating a group of VAL UEs, or all VAL UEs as measurement target VAL UEs, and optionally, all the VAL UEs might have established SEALDD connections with the second network function. The method may further comprise the step of transmitting, to the first network function, a notification message for providing the reporting of the transmission quality measurement.

In an embodiment, the method may further comprise the step of after receiving the subscription message and before transmitting the notification message, identifying SEALDD connections corresponding to the measurement target VAL UEs to trigger measurement.

In an embodiment, the first parameter may comprise a group ID of the group of VAL UEs, or an indication to indicate all the VAL UEs.

In an embodiment, the group of VAL UEs may include a plurality of VAL UEs sharing the same VAL service and/or being located in the same geographic area.

In an embodiment, the subscription message may further include a second parameter indicating a reporting periodicity if the reporting is set to a periodic reporting.

In an embodiment, the subscription message may further include a third parameter indicating a reporting granularity.

In an embodiment, the reporting granularity may indicate whether the requested reporting is for a specific VAL UE, an individual VAL UE of multiple VAL UEs, the group of VAL UEs, or all the VAL UEs.

In an embodiment, the subscription message may further include a fourth parameter indicating one or more measurement conditions for the transmission quality measurement.

In an embodiment, the one or more measurement conditions may include one or more spatial conditions and/or one or more temporal conditions.

In an embodiment, if the one or more conditions are not satisfied, the SEALDD server may stop or suspend the transmission quality measurement.

In an embodiment, the method may further comprise the step of repeatedly performed the following steps for each of the group of VAL UEs or all the VAL UEs: performing the transmission quality measurement to obtain one or more measurement values; and generating one or more transmission quality measurement reports, based on the one or more measurement values.

In an embodiment, the method may further comprise the step of aggregating the one or more transmission quality measurement reports, to form an aggregated transmission quality measurement report.

In an embodiment, the notification message may further include a fifth parameter indicating one or more VAL UEs for which transmission quality are measured and/or reporting of the transmission quality measurements are provided based on the third parameter.

In an embodiment, if the third parameter is set to a specific VAL UE or an individual VAL UE of multiple VAL UEs, the transmission quality measurement for the one or more VAL UEs may be a transmission quality measurement value for the specific VAL UE or the individual VAL UE.

In an embodiment, if the third parameter is set to multiple VAL UEs, the transmission quality measurement for the one or more VAL UEs may be an aggregation of transmission quality measurement values for the group of VAL UEs or all the VAL UEs.

In an embodiment, the notification message may further include a sixth parameter indicating an average measurement value of a plurality of transmission quality measurement values for the group of VAL UEs or all the VAL UEs.

In an embodiment, the subscription message may be a SEALDD enabled data transmission quality measurement subscription request.

In an embodiment, the notification message may be a SEALDD enabled data transmission quality measurement notification.

In an embodiment, the transmission quality measurement may be a measurement on any one of latency, bitrate, or packet loss rate.

In some embodiments, there proposes a network function, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above network functions. In an embodiment, the network function may be configured as the above first network function or the second network function.

In some embodiments, there proposes a computer readable medium stores computer readable code, which when run on an apparatus, may cause the apparatus to perform any of the above methods.

In some embodiments, there proposes a computer program product stores computer readable code, which when run on an apparatus, may cause the apparatus to perform any of the above methods.

With the embodiments herein, the QoS measurement in SEALDD layer may be improved to support multiple VAL UEs in one subscription; otherwise, the VAL server needs to transmit many subscription requests (one per UE data flow).

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing generic on-network functional model of SEAL;

FIG. 2 is a schematic block diagram showing the on-network functional model of SEAL for DD;

FIG. 3 is a schematic block diagram showing example architecture for SEAL application traffic transfer;

FIG. 4 is a schematic signaling chart showing the messages in SEALDD enabled data transmission quality measurement procedure according to the embodiments herein;

FIG. 5 is a schematic flow chart showing an example method in the first network function, according to the embodiments herein;

FIG. 6 is a schematic flow chart showing an example method in the second network function, according to the embodiments herein;

FIG. 7 is a schematic block diagram showing an example first network function, according to the embodiments herein;

FIG. 8 is a schematic block diagram showing an example second network function, according to the embodiments herein; and

FIG. 9 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

Currently, the SEALDD data transmission quality measurement only supports a single UE in one subscription, for example the UE ID or address shall be provided in the SEALDD transmission quality measurement subscription request. When the single UE is not provided, for example the UE ID or address is not provided in the SEALDD transmission quality measurement subscription request, it is not clear how the measurement will be done by the SEALDD server (whether all UEs or random UE will be measured).

To avoid indeterministic measurement, the embodiments propose a solution to support all UEs as measurement target; and to support transmission quality measurement report for a group of VAL UEs or multiple VAL UEs.

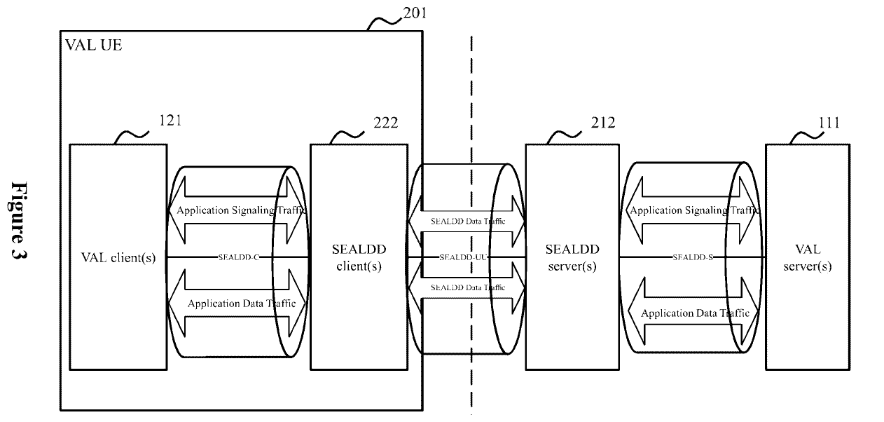

The embodiments may be implemented in the architecture for SEAL Data Delivery service as shown in FIGS. 2 and 3.

In an embodiment, the architecture 200 may be configured in an OTT scenario. The OTT connection may be transparent in the sense that the participating communication devices through which the OTT connection passes are unaware of routing of uplink and downlink communications. For example, a base station may not or needs not be informed about the past routing of an incoming downlink communication with data originating from the VAL server(s) 111 or the SEALDD server(s) 212 to be forwarded (e.g., handed over) to a connected UE 201. Similarly, the base station needs not be aware of the future routing of an outgoing uplink communication originating from the UE 201 towards the VAL server(s) 111 or the SEALDD server(s) 212.

It should also be understood that, a network function can be implemented either as a network element on a dedicated hardware, as a software instance running on a dedicated hardware, or as a virtualized function instantiated on an appropriate platform, e.g., on a cloud infrastructure.

As used herein, a UE 101 or 201 refers to a device capable, configured, arranged and/or operable to communicate wirelessly with network nodes and/or other UEs. Examples of a UE 101 or 201 include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE 101 or 201 may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE 101 or 201 may not necessarily have a user in the sense of a human user who owns and/or operates the relevant device. Instead, a UE 101 or 201 may represent a device that is intended for sale to, or operation by, a human user but which may not, or which may not initially, be associated with a specific human user (e.g., a smart sprinkler controller). Alternatively, a UE 101 or 201 may represent a device that is not intended for sale to, or operation by, an end user but which may be associated with or operated for the benefit of a user (e.g., a smart power meter).

Note that, although 3GPP network system 102 is used herein as an example, the embodiments herein may be also applicable to non-3GPP network(s). In that sense, the network system 102 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

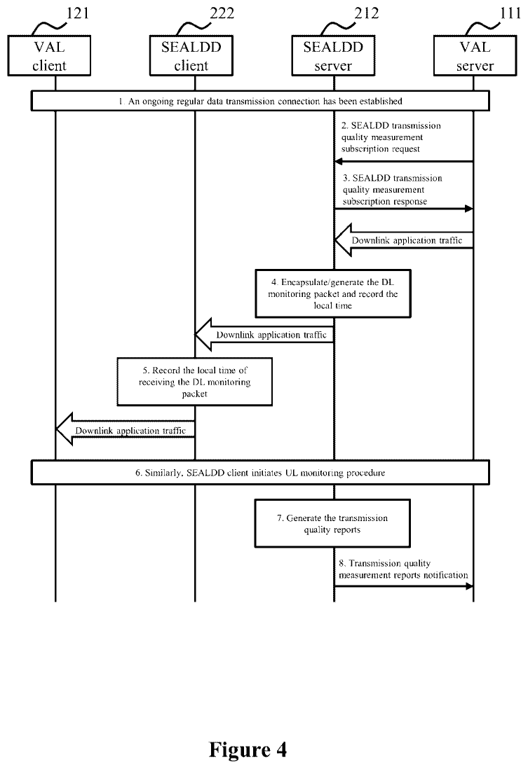

FIG. 4 is a schematic signaling chart showing the messages in SEALDD enabled data transmission quality measurement procedure according to the embodiments herein. The SEALDD client 222 and SEALDD server 212 may be enhanced by carrying out the data transmission quality measurement.

Before performing the data transmission quality measurement procedure, the SEALDD server 212 and the SEALDD client 222 may be synchronized to the time source provided by 5GS as specified in 3GPP TS 23.501, and the VAL server 111 may discover and select the SEALDD server 212 by Common API Framework (CAPIF) functions.

In an embodiment, the signaling chart in FIG. 4 may include the following messages or steps:
Step 1. The on-going regular data transmission connection may be established according to clause 9.2.2.2 of 3GPP TS 23.433.
Step 2. The VAL server 111 may send a SEALDD transmission quality measurement subscription request to the SEALDD server 212. The request may include the identifiers of the application traffic (e.g. VAL service ID, VAL server ID), requirement of transmission quality measurement (e.g. latency, bitrate, packet loss rate) and measurement target UE (a single UE, a group of UEs or all UEs), and may also include reporting frequency, spatial condition and temporal condition.

In an example, a group of VAL UE or a VAL UE group may include a plurality of VAL UEs 201 sharing the same VAL service and/or being located in the same geographic area.

The following table 1 describes information flow from the VAL server 111 to the SEALDD server 212 for subscribing the data transmission measurement service.

TABLE 1
SEALDD transmission quality measurement subscription request

| Information element | Status | Description |
|---|---|---|
| Application traffic identifiers | M | Identify of the application traffic (e.g. VAL server |
| | | ID, VAL service ID) |
| VAL UE identity | O | Identifier of specific VAL UE need to be measured, |
| | (See NOTE) | e.g. UE ID, UE address |
| VAL UE group ID | O | Identifier of a specific VAL UE group. |
| | (See NOTE) | |
| All VAL UEs Indication | O | Indicates all VAL UEs of the application identified |
| | (See NOTE) | by application traffic identifiers. |
| Measurement conditions | O | Indicates the temporal and/or spatial conditions. |
| Transmission quality | M | The measurement requirement information |
| measurement requirements list | | |
| >Measurement ID | M | Measurement identifiers, e.g. latency, bitrate, |
| | | packet loss rate |
| >Reporting frequency | O | The reporting frequency of measurement results |
| | | (e.g. periodic reporting). If not present, it implies |
| | | periodic reporting. |
| >Reporting periodicity | O | If the reporting frequency is periodic, the reporting |
| | | periodicity shall be provided. For multiple UEs, it is |
| | | recommended to give sufficient time to allow report |
| | | aggregation. |
| >Reporting granularity | O | The reporting granularity indicates whether the |
| | | measurement report is for individual VAL UE or for |
| | | VAL UE group or for all VAL UEs, if VAL UE group |
| | | or all VAL UEs is the measurement target. |
| >Measurement period window | O | Indicates the measurement period window |
| >measurement expiration time | O | Indicates the measurement expiration time |

NOTE:
One of them shall be present as the measurement target UE.

As shown in table 1, an information element “VAL UE group ID”, which is a group identifier (ID) of the group of VAL UEs, or an information element “All VAL UEs Indication”, which is an indication to indicate all the VAL UEs, may be provided in the subscription request to requesting a reporting of a transmission quality measurement for one or more VAL UEs.

In addition, an information element “Reporting frequency” may be provided in the subscription request to indicate whether the reporting shall be a periodic reporting. If the reporting is set to a periodic reporting, an information element “Reporting periodicity” may be provided in the subscription request to indicate the reporting periodicity.

In addition, an information element “Reporting granularity” may be provided in the subscription request to indicate whether the reporting shall be provided per UE or an aggregation for multiple UEs. The reporting granularity may indicate whether the requested reporting is for a specific VAL UE, an individual VAL UE of multiple VAL UEs, the group of VAL UE, or all the VAL UEs.

In addition, an information element “Measurement conditions” may be provided in the subscription request to indicate one or more spatial conditions and/or one or more temporal conditions for the measurement. If the one or more conditions are not satisfied, the SEALDD server 212 may stop or suspend the transmission quality measurement.

In an example, the VAL server 111 may send measurement request to the SEALDD server 212 with geographical areas or scheduled route (spatial conditions), and/or start-stop time (temporal conditions) with optional time periodicity.

For an example, the measurement is expected to be done for the VAL UE(s) 201 located in a park or campus, from 9:00 am to 6:00 pm every day.

For another example, the measurement is expected to be done for VAL UE(s) 201 (e.g. a group of V2X UE) with scheduled route (from city A to city B via highway A2 and A3), from 9:00 am to 11:am on Tuesday and from 1:pm to 5:00 pm on Thursday, until 2025 September.
Step 3. Upon receiving the request, the SEALDD server 212 may perform an authorization check. If the authorization check is successful, the SEALDD server 212 may send a response to the VAL server 111 with the subscription ID, an expiration time.

The following table 2 describes the information flow from the SEALDD server 212 to the VAL server 111 for responding to the transmission quality measurement subscription request.

TABLE 2
SEALDD transmission quality measurement subscription response

| Information | | |
|---|---|---|
| element | Status | Description |
| Result | M | Success or failure. |
| Subscription | M | Subscription identifier corresponding |
| ID | | to the subscription. |
| Expiration | O | Indicates the expiration time of the subscription. |
| time | | Applicable for successful result. |

Step 4. The SEALDD server 212 may initiate the Downlink (DL) packet delay measurement based on the request from the VAL server 111 in step 2. The SEALDD server 212 may encapsulate the DL monitoring packet (i.e. DL SEALDD packet with SEALDD DL monitoring header and VAL traffic as payload, or dummy DL SEALDD packet generated for data transmission quality monitoring) with local time T1 when the SEALDD server 212 sends out the DL monitoring packets. The SEALDD server 212 may consider the spatial and/or temporal conditions when starting/resuming the transmission quality measurement. If the conditions are not satisfied, the SEALDD server 212 may stop/suspend the transmission quality measurement.
Step 5. The SEALDD client 222 may receive the DL monitoring packet, and record the local time T2. Note that dummy packet is not sent to VAL client 222.
Step 6. Similarly, the SEALDD client 222 may encapsulate the uplink (UL) monitoring packet (i.e. UL SEALDD packet with SEALDD UL monitoring header and VAL traffic as payload, or dummy UL SEALDD packet generated for data transmission quality monitoring) with local time T2 when the SEALDD client 222 receives the DL monitoring packet and local time T3 when the SEALDD client 222 sends out the UL monitoring packet.
Step 7. The SEALDD server 212 may record the local time T4 when the SEALDD server 212 receives the UL monitoring packet and calculates the packet delay with T1, T2, T3, T4. The SEALDD server 212 may also calculate the bitrate and packet loss rate over a certain period over a specific SEALDD connection by recording the status of the SEALDD packets carrying VAL traffic or dummy SEALDD packets generated for transmission quality measurement reports.
Step 8. The SEALDD server 212 may report the data transmission quality measurement results (e.g. packet delay, bitrate, packet error rate) to the VAL server 111 via the notification message.

When a group of VAL UEs or all VAL UEs indication is received in step 2, the step 4 to step 7 may be repeated for VAL UEs in the group or for all VAL UEs. The SEALDD server 212 may identify SEALDD connections corresponding to the desired VAL UE(s) 201 to trigger measurement. And depending on the reporting requirement for multiple VAL UEs 201, the SEALDD server 212 may calculate the needed report for the VAL server 111. For example, the SEALDD server 212 may aggregate the one or more transmission quality measurement results, to form an aggregated transmission quality measurement result (such as average measurement value, minimum measurement value, and maximum measurement value).

The following table 3 describes the information flow from the SEALDD server 212 to the VAL server 111 for notifying the transmission quality measurement reports.

TABLE 3
SEALDD transmission quality measurement notification

| Information element | Status | Description |
|---|---|---|
| Subscription ID | M | Subscription identifier corresponding to the |
| | | subscription. |
| Transmission quality | M | The generated transmission quality results in |
| measurement reports list | | SEALDD server |
| >Measurement ID | M | Measurement identifiers, e.g. latency, bitrate, |
| | | packet loss rate |
| >VAL UE ID(s) | M | It indicates the VAL UE(s) under SEALDD |
| | | measurement. For a single VAL UE or multiple VAL |
| | | UEs with reporting granularity set to individual UE, |
| | | the associated measurement values are for the |
| | | single or individual VAL UE as indicated in this IE. |
| | | For multiple VAL UEs with reporting granularity set |
| | | to VAL UE group or all VAL UEs, the associated |
| | | measurement values are aggregation for all VAL |
| | | UEs or the VAL UE group and this IE includes the |
| | | measured VAL UEs. |
| >Average measurement value | O | The average measurement value of measurement |
| | | results |
| >Minimum measurement value | O | The minimum measurement value of measurement |
| | | results |
| >maximum measurement value | O | The maximum measurement value of |
| | | measurement results |
| >Measurement period | O | Indicates the measurement period |
| >Timestamp | O | Indicates the timestamp of measurement results |

When the measurement target is for a group of UEs or all UEs, the report may be per UE or an aggregation for the group or all UEs (e.g. average measurement, maximum measurement) depending on reporting requirement. As shown in table 3, an information element “VAL UE ID(s)” may be provided in the notification to show whether the transmission quality measurement and/or report is per UE or an aggregation for multiple UEs.

If the information element “Reporting granularity” in the subscription request is set to a specific VAL UE or is set to an individual VAL UE of multiple VAL UEs, the transmission quality measurement for the one or more VAL UEs may be a transmission quality measurement value for the specific VAL UE or the individual VAL UE.

If the information element “Reporting granularity” in the subscription request is set to multiple UEs, the transmission quality measurement for the one or more VAL UEs may be an aggregation of transmission quality measurement values for the group of VAL UEs or all the VAL UEs.

In an example, for the vehicles in a fleet, an average measurement value of the transmission quality for the vehicles may be used for the reselection of the SEALDD server 212. As shown in table 3, an information element “Average measurement value” may be provided in the notification to indicate an average measurement value of a plurality of transmission quality measurement values for the group of VAL UEs or all the VAL UEs.

With the data transmission quality measurement procedure in FIG. 4, the embodiments herein may support multiple VAL UEs in SEALDD Data transmission quality measurement subscription and support different format reports (e.g. average value) for multiple VAL UEs. As a result, the QoS measurement in SEALDD layer may be improved to support multiple VAL UEs in one subscription; otherwise, the VAL server needs to transmit many subscription requests (one per UE data flow).

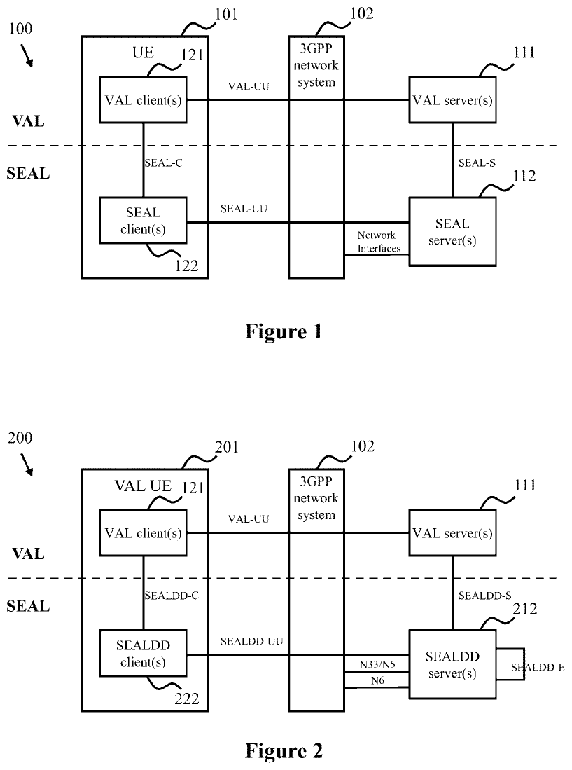

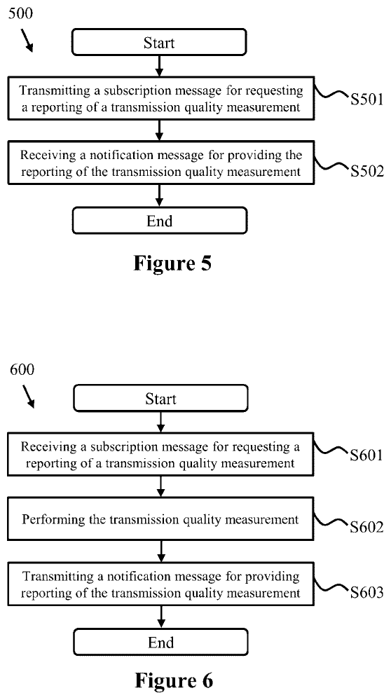

FIG. 5 is a schematic flow chart showing an example method 500 in the first network function, according to the embodiments herein. In an embodiment, the flow chart in FIG. 5 may be implemented in the VAL server 111 in FIGS. 1-4.

The method 500 may begin with step S501, in which the first network function (such as the VAL server 111) may transmit, to a second network function implementing a SEALDD server (such as the SEALDD server 212), a subscription message for requesting a reporting of a transmission quality measurement for one or more VAL UEs. The subscription message may include a first parameter indicating a group of VAL UEs, or all VAL UEs as measurement target VAL UEs. Optionally, all the VAL UEs might have established SEALDD connections with the second network function.

In an embodiment, the first parameter may comprise a group identifier (ID) of the group of VAL UEs, or an indication to indicate all the VAL UEs.

In an embodiment, the group of VAL UEs may include a plurality of VAL UEs sharing the same VAL service and/or being located in the same geographic area.

In an embodiment, the subscription message may further include a second parameter indicating a reporting periodicity if the reporting is set to a periodic reporting.

In an embodiment, the subscription message may further include a third parameter indicating a reporting granularity.

In an embodiment, the reporting granularity may indicate whether the requested reporting is for a specific VAL UE, an individual VAL UE of multiple VAL UEs, the group of VAL UEs, or all the VAL UEs.

In an embodiment, the subscription message may further include a fourth parameter indicating one or more measurement conditions for the transmission quality measurement.

In an embodiment, the one or more measurement conditions may include one or more spatial conditions and/or one or more temporal conditions.

In an embodiment, if the one or more conditions are not satisfied, the SEALDD server may stop or suspend the transmission quality measurement.

In an embodiment, the subscription message may be a SEALDD enabled data transmission quality measurement subscription request.

In an embodiment, the transmission quality measurement may be a measurement on any one of latency, bitrate, or packet loss rate.

Then, the method 500 may proceed to step S502, in which the first network function (such as the VAL server 111) may receive, from the second network function, a notification message for providing the reporting of the transmission quality measurement.

In an embodiment, the notification message may further include a fifth parameter indicating one or more VAL UEs for which transmission quality are measured and/or reporting of the transmission quality measurements are provided based on the third parameter.

In an embodiment, if the third parameter is set to a specific VAL UE or an individual VAL UE of multiple VAL UEs, the transmission quality measurement for the one or more VAL UEs may be a transmission quality measurement value for the specific VAL UE or the individual VAL UE.

In an embodiment, if the third parameter is set to multiple VAL UEs, the transmission quality measurement for the one or more VAL UEs may be an aggregation of transmission quality measurement values for the group of VAL UEs or all the VAL UEs.

In an embodiment, the notification message may further include a sixth parameter indicating an average measurement value of a plurality of transmission quality measurement values for the group of VAL UEs or all the VAL UEs.

In an embodiment, the notification message may be a SEALDD enabled data transmission quality measurement notification.

The above steps are only examples, and the first network function may perform any related actions described with respect to FIGS. 1-4.

FIG. 6 is a schematic flow chart showing an example method 600 in the second network function, according to the embodiments herein. In an embodiment, the flow chart in FIG. 6 may be implemented in the SEALDD server 212 in FIGS. 2-4.

The method 600 may begin with step S601, in which the second network function (such as the SEALDD server 212) may receive, from a first network function implementing a VAL server (such as the VAL server 111), a subscription message for requesting a reporting of a transmission quality measurement for one or more VAL UEs. The subscription message may include a first parameter indicating a group of VAL UEs, or all VAL UEs as measurement target VAL UEs. Optionally, all the VAL UEs might have established SEALDD connections with the second network function.

In an embodiment, the first parameter may comprise a group ID of the group of VAL UEs, or an indication to indicate all the VAL UEs.

In an embodiment, the group of VAL UEs may include a plurality of VAL UEs sharing the same VAL service and/or being located in the same geographic area.

In an embodiment, the subscription message may further include a second parameter indicating a reporting periodicity if the reporting is set to a periodic reporting.

In an embodiment, the subscription message may further include a third parameter indicating a reporting granularity.

In an embodiment, the reporting granularity may indicate whether the requested reporting is for a specific VAL UE, an individual VAL UE of multiple VAL UEs, the group of VAL UEs, or all the VAL UEs.

In an embodiment, the subscription message may further include a fourth parameter indicating one or more measurement conditions for the transmission quality measurement.

In an embodiment, the one or more measurement conditions may include one or more spatial conditions and/or one or more temporal conditions.

In an embodiment, if the one or more conditions are not satisfied, the SEALDD server may stop or suspend the transmission quality measurement.

In an embodiment, the subscription message may be a SEALDD enabled data transmission quality measurement subscription request.

In an embodiment, the transmission quality measurement may be a measurement on any one of latency, bitrate, or packet loss rate.

In an embodiment, after receiving the subscription message, the second network function (such as the SEALDD server 212) may identify SEALDD connections corresponding to the measurement target VAL UEs to trigger measurement.

Then, the method 600 may proceed to step S602, in which the second network function (such as the SEALDD server 212) may perform the transmission quality measurement.

In an embodiment, the second network function may repeatedly perform the following steps for each of the group of VAL UEs or all the VAL UEs: performing the transmission quality measurement to obtain one or more measurement values; and generating one or more transmission quality measurement reports, based on the one or more measurement values.

In an embodiment, the method may further comprise the step of aggregating the one or more transmission quality measurement reports, to form an aggregated transmission quality measurement report.

Then, the method 600 may proceed to step S603, in which the second network function (such as the SEALDD server 212) may transmit, to the first network function, a notification message for providing the reporting of the transmission quality measurement.

In an embodiment, the notification message may further include a fifth parameter indicating one or more VAL UEs for which transmission quality are measured and/or reporting of the transmission quality measurements are provided based on the third parameter.

In an embodiment, if the third parameter is set to a specific VAL UE or an individual VAL UE of multiple VAL UEs, the transmission quality measurement for the one or more VAL UEs may be a transmission quality measurement value for the specific VAL UE or the individual VAL UE.

In an embodiment, if the third parameter is set to multiple VAL UEs, the transmission quality measurement for the one or more VAL UEs may be an aggregation of transmission quality measurement values for the group of VAL UEs or all the VAL UEs.

In an embodiment, the notification message may further include a sixth parameter indicating an average measurement value of a plurality of transmission quality measurement values for the group of VAL UEs or all the VAL UEs.

In an embodiment, the notification message may be a SEALDD enabled data transmission quality measurement notification.

The above steps are only examples, and the second network function may perform any related actions described with respect to FIGS. 2-4.

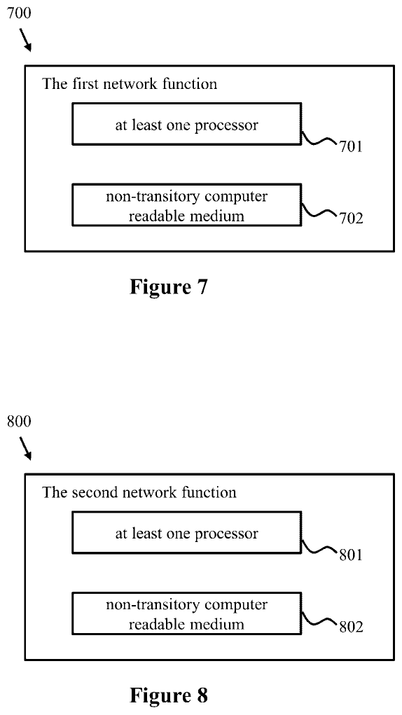

FIG. 7 is a schematic block diagram showing an example first network function 700, according to the embodiments herein. In an embodiment, the example first network function 700 in FIG. 7 may be implemented as the VAL server 111 in FIGS. 1-4.

In an embodiment, the first network function 700 may include at least one processor 701; and a non-transitory computer readable medium 702 coupled to the at least one processor 701. The non-transitory computer readable medium 702 may store instructions executable by the at least one processor 701, whereby the at least one processor 701 is configured to perform the steps in the example method 500 as shown in the schematic flow charts of FIG. 5; the details thereof are omitted here.

Note that, the first network function 700 may be implemented as hardware, software, firmware and any combination thereof. For example, the first network function 700 may include a plurality of units, circuities, modules or the like, each of which may be used to perform one or more steps of the example method 500 or one or more steps shown in FIGS. 1-4 related to the first network function (such as the VAL server 111).

FIG. 8 is a schematic block diagram showing an example second network function 800, according to the embodiments herein. In an embodiment, the example second network function 800 in FIG. 8 may be implemented as the SEALDD server 212 in FIGS. 2-4.

In an embodiment, the second network function 800 may include at least one processor 801; and a non-transitory computer readable medium 802 coupled to the at least one processor 801. The non-transitory computer readable medium 802 may store instructions executable by the at least one processor 801, whereby the at least one processor 801 is configured to perform the steps in the example method 600 as shown in the schematic flow charts of FIG. 6; the details thereof are omitted here.

Note that, the second network function 800 may be implemented as hardware, software, firmware and any combination thereof. For example, the second network function 800 may include a plurality of units, circuities, modules or the like, each of which may be used to perform one or more steps of the example method 600 or one or more steps shown in FIGS. 2-4 related to the second network function (such as the SEALDD server 212).

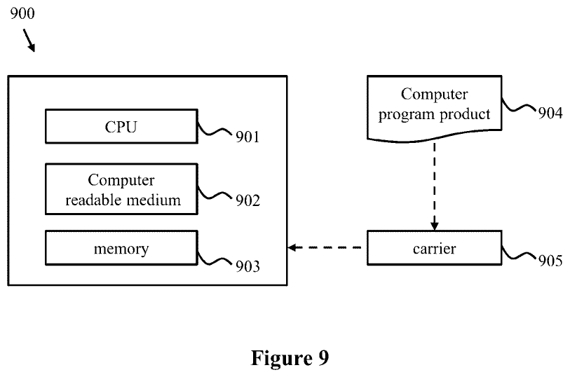

FIG. 9 is a schematic block diagram showing an example computer-implemented apparatus 900, according to the embodiments herein. In an embodiment, the apparatus 900 may be configured as the above mentioned apparatus, such as the UE 101 or its functional component (such as the VAL client(s) 121 and/or the SEAL client(s) 122), the UE 201 or its functional component (such as the VAL client(s) 121 and/or the SEALDD client(s) 222), the first network function (such as the VAL server(s) 111), or the second network function (such as the SEALDD server 212).

In an embodiment, the apparatus 900 may include but not limited to at least one processor such as Central Processing Unit (CPU) 901, a computer-readable medium 902, and a memory 903. The memory 903 may comprise a volatile (e.g., Random Access Memory, RAM) and/or non-volatile memory (e.g., a hard disk or flash memory). In an embodiment, the computer-readable medium 902 may be configured to store a computer program and/or instructions, which, when executed by the processor 901, causes the processor 901 to carry out any of the above mentioned methods.

In an embodiment, the computer-readable medium 902 (such as non-transitory computer readable medium) may be stored in the memory 903. In another embodiment, the computer program may be stored in a remote location for example computer program product 904 (also may be embodied as computer-readable medium), and accessible by the processor 901 via for example carrier 905.

The computer-readable medium 902 and/or the computer program product 904 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Report 3GPP TS 23.433 v1.1.0 (2023-January).

Title: SEALDD QoS measurement for multiple UEs

### Introduction

This pCR adds support for multiple UEs in the SEALDD QoS measurement.

### Reason for Change:

The current SEALDD data transmission quality measurement supports a single UE. When the single UE is not provided, it is not clear how the measurement will be done by the SEALDD server (whether all UEs or random UE will be measured)

To avoid indeterministic measurement, it is suggested to support all UEs as measurement target. And it should also be possible to get transmission quality measurement report for a group of UEs.

When the measurement target is for a group of UEs or all UEs, the report can be per UE or an aggregation for the group or all UEs (e.g. average measurement, max. measurement) depending on reporting requirement.

### Proposed Changes:

*** 1st Change *** (the proposed change includes the content to be added to (shown by underline) and to be removed from (shown by deleting line) the 3GPP TS 23.433 v1.1.0 (2023-January))

### 9.7.2.1 Data Transmission Quality Measurement

Figure (Referring to FIG. 4) illustrate the procedure for SEALDD enabled data transmission quality measurement. The SEALDD client and SEALDD server is enhanced to carry out the data transmission quality measurement.

### Pre-Conditions:

1. The SEALDD server and SEALDD client are synchronized to the time source provided by 5GS as specified in 3GPP TS 23.501 [5].
2. The VAL server discovers and selects the SEALDD server by CAPIF functions.

Figure (Referring to FIG. 4): SEALDD enabled data transmission quality measurement procedure
1. The on-going regular data transmission connection is established according to clause 9.2.2.2
2. The VAL server sends a SEALDD transmission quality measurement subscription request to the SEALDD server. The request includes the identifiers of the application traffic (e.g. VAL service ID, VAL server ID), requirement of transmission quality measurement (e.g. latency, bitrate, packet loss rate) and measurement target UE (a single UE, a group of UEs or all UEs), and may also include reporting frequency, spatial condition and temporal condition.
3. Upon receiving the request, the SEALDD server performs an authorization check. If authorization is successful, the SEALDD server sends a response to the VAL server with the subscription ID, expiration time.
4. The SEALDD server initiates the DL packet delay measurement based on the request from VAL server in step 2. The SEALDD server encapsulates the DL monitoring packet (i.e. DL SEALDD packet with SEALDD DL monitoring header and VAL traffic as payload, or dummy DL SEALDD packet generated for data transmission quality monitoring) with local time T1 when the SEALDD server sends out the DL monitoring packets. The SEALDD server considers the spatial and/or temporal conditions when starting/resuming the transmission quality measurement. If the conditions are not satisfied, the SEALDD server stops/suspends the transmission quality measurement.
5. The SEALDD client receives the DL monitoring packet, and records the local time T2.
NOTE: Dummy packet is not sent to VAL client.
6. Similarly, the SEALDD client encapsulates the UL monitoring packet (i.e. UL SEALDD packet with SEALDD UL monitoring header and VAL traffic as payload, or dummy UL SEALDD packet generated for data transmission quality monitoring) with local time T2 when the SEALDD client receives the DL monitoring packet and local time T3 when the SEALDD client sends out the UL monitoring packet.
7. The SEALDD server records the local time T4 when the SEALDD server receives the UL monitoring packet and calculates the packet delay with T1, T2, T3, T4. The SEALDD server can also calculate the bitrate and packet loss rate over a certain period over a specific SEALDD connection by recording the status of the SEALDD packets carrying VAL traffic or dummy SEALDD packets generated for transmission quality measurement reports.
8. The SEALDD server reports the data transmission quality measurement results (e.g. packet delay, bitrate, packet error rate) to the VAL server via the notification message.

When a group of VAL UEs or all VAL UEs indication is received in step 2, step 4 to step 7 is repeated for VAL UEs in the group or for all VAL UEs. The SEALDD server identifies SEALDD connections corresponding to the desired VAL UE(s) to trigger measurement. And depending on the reporting requirement for multiple UEs, the SEALDD server calculates the needed report for the VAL server.

Editor's Note: Whether and how the SEALDD server can provide the related API to allow other consumers (e.g. VAL server, SEALDD server, NSCE server, etc) to invoke to query the measurement result is FFS.

*** 2nd Change *** (the proposed change includes the content to be added to (shown by underline) the 3GPP TS 23.433 v1.1.0 (2023-January))

9.7.3.1 SEALDD enabled data transmission quality measurement subscription request

Table 9.7.3.1-1 describes the information flow from the VAL server to the SEALDD server for subscribing the data transmission measurement service.

TABLE 9.7.3.1-1
SEALDD transmission quality measurement subscription request

| Information element | Status | Description |
|---|---|---|
| Application traffic identifiers | M | Identify of the application traffic (e.g. VAL server |
| | | ID, VAL service ID) |
| VAL UE identity | O | Identifier of specific VAL UE need to be measured, |
| | (See | e.g. UE ID, UE address |
| | NOTE) | |
| VAL UE group ID | O | Identifier of a specific VAL UE group. |
| | (See | |
| | NOTE) | |
| All VAL UEs Indication | O | Indicates all VAL UEs of the application |
| | (See | identified by application traffic |
| | NOTE) | identifiers. |
| Measurement conditions | O | Indicates the temporal and/or |
| | | spatial conditions. |
| Transmission quality | M | The measurement requirement information |
| measurement requirements list | | |
| >Measurement ID | M | Measurement identifiers, e.g. latency, bitrate, |
| | | packet loss rate |
| >Reporting frequency | O | The reporting frequency of measurement results |
| | | (e.g. periodic reporting). If not present, |
| | | it implies periodic reporting. |
| >Reporting periodicity | O | If the reporting frequency is periodic, the |
| | | reporting periodicity shall be provided. |
| | | For multiple UEs, it is recommended to give |
| | | sufficient time to allow report aggregation. |
| >Reporting granularity | O | The reporting granularity indicates whether |
| | | the measurement report is for individual VAL |
| | | UE or for VAL UE group or for all VAL UEs, |
| | | if VAL UE group or all VAL UEs is the |
| | | measurement target. |
| >Measurement period window | O | Indicates the measurement period window |
| >measurement expiration time | O | Indicates the measurement expiration time |

NOTE:
One of them shall be present as the measurement target UE.

*** 3rd Change *** (the proposed change includes the content to be added to (shown by underline) and to be removed from (shown by deleting line) the 3GPP TS 23.433 v1.1.0 (2023-January))

9.7.3.2 SEALDD enabled data transmission quality measurement subscription response

Table 9.7.3.2-1 describes the information flow from the SEALDD server to the VAL server for responding to the transmission quality measurement subscription request.

TABLE 9.7.3.2-1
SEALDD transmission quality measurement subscription response

| Information | | |
|---|---|---|
| element | Status | Description |
| Result | M | Success or failure. |
| Subscription | M [symbol] | Subscription identifier corresponding |
| ID | | to the subscription. |
| Expiration | O | Indicates the expiration time of the subscription. |
| time | | Applicable for successful result. |

***4th Change *** (the proposed change includes the content to be added to (shown by underline) and to be removed from (shown by deleting line) the 3GPP TS 23.433 v1.1.0 (2023-January))

9.7.3.3 SEALDD enabled data transmission quality measurement notification

Table 9.7.3.3-1 describes the information flow from the SEALDD server to the VAL server for notifying the transmission quality measurement reports.

TABLE 9.7.3.3-1
SEALDD transmission quality measurement notification

| Information element | Status | Description |
|---|---|---|
| Subscription ID | M | Subscription identifier corresponding to the |
| | | subscription. |
| Transmission quality | M | The generated transmission quality results in |
| measurement reports list | | SEALDD server |
| >Measurement ID | M | Measurement identifiers, e.g. latency, bitrate, |
| | | packet loss rate |
| >VAL UE ID(s) | M | It indicates the VAL UE(s) under SEALDD |
| | | measurement. For a single VAL UE or multiple |
| | | VAL UEs with reporting granularity set to |
| | | individual UE, the associated measurement |
| | | values are for the single or individual VAL UE |
| | | as indicated in this IE. For multiple VAL UEs |
| | | with reporting granularity set to VAL UE group |
| | | or all VAL UEs, the associated measurement |
| | | values are aggregation for all VAL UEs or the |
| | | VALUE group and this IE includes the |
| | | measured VAL UEs. |
| >Average measurement value | O | The average measurement value of |
| | | measurement results |
| >Minimum measurement value | O | The minimum measurement value of measurement |
| | | results |
| >maximum measurement value | O | The maximum measurement value of |
| | | measurement results |
| >Measurement period | O | Indicates the measurement period |
| >Timestamp | O | Indicates the timestamp of measurement results |

[symbol]

[symbol]

[symbol]

[symbol]

[symbol]

*** End of Changes ***

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

### Abbreviations

3GPP 3rd Generation Partnership Project
API Application Programming Interface
DD Data Delivery
DL Downlink
OTT Over The Top
QoS Quality of Service
SEAL Service Enablement Architecture Layer for Verticals
SEALDD SEAL Data Delivery
UE User Equipment
UP Uplink
V2X vehicle to everything
VAL Vertical Application Layer.

1. A method performed by a first network function implementing a Vertical Application Layer (VAL) server, comprising:
transmitting, to a second network function implementing a Service Enabler Architecture Layer (SEAL) Data Delivery (DD) server, a subscription message for requesting a reporting of a transmission quality measurement for one or more VAL User Equipments (UE), wherein the subscription message includes a first parameter indicating a group of VAL UEs, or all VAL UEs as measurement target VAL UEs; and
receiving, from the second network function, a notification message for providing the reporting of the transmission quality measurement.

2. The method according to claim 1, wherein the first parameter comprises a group identifier (ID) of the group of VAL UEs, or an indication to indicate all the VAL UEs;
wherein the group of VAL UEs includes a plurality of VAL UEs sharing the same VAL service and/or being located in the same geographic area;
wherein the subscription message further includes a second parameter indicating a reporting periodicity if the reporting is set to a periodic reporting; and/or
wherein the subscription message further includes a third parameter indicating a reporting granularity; wherein the reporting granularity indicates whether the requested reporting is for a specific VAL UE, an individual VAL UE of multiple VAL UEs, the group of VAL UEs, or all the VAL UEs.

3-5. (canceled)

6. The method according to claim 1, wherein the subscription message further includes a fourth parameter indicating one or more measurement conditions for the transmission quality measurement.

7. The method according to claim 6, wherein the one or more measurement conditions include one or more spatial conditions and/or one or more temporal conditions; and/or
wherein if the one or more conditions are not satisfied, the SEALDD server stops or suspends the transmission quality measurement.

8. The method according to claim 1, wherein the notification message further includes a fifth parameter indicating one or more VAL UEs for which transmission quality are measured and/or reporting of the transmission quality measurements are provided based on the third parameter.

9. The method according to claim 8, wherein if the third parameter is set to a specific VAL UE or an individual VAL UE of multiple VAL UEs, the transmission quality measurement for the one or more VAL UEs is a transmission quality measurement value for the specific VAL UE or the individual VAL UE; and if the third parameter is set to multiple VAL UEs, the transmission quality measurement for the one or more VAL UEs is an aggregation of transmission quality measurement values for the group of VAL UEs or all the VAL UEs.

10. The method according to claim 1, wherein the notification message further includes a sixth parameter indicating an average measurement value of a plurality of transmission quality measurement values for the group of VAL UEs or all the VAL UEs;
wherein the subscription message is a SEALDD enabled data transmission quality measurement subscription request;
wherein the notification message is a SEALDD enabled data transmission quality measurement notification; and/or
wherein the transmission quality measurement is a measurement on any one of latency, bitrate, or packet loss rate.

11. (canceled)

12. A method performed by a second network function implementing a Service Enabler Architecture Layer (SEAL) Data Delivery (DD) server, comprising:
receiving, from a first network function implementing a Vertical Application Layer (VAL) server, a subscription message for requesting a reporting of a transmission quality measurement for one or more VAL User Equipments (UE), wherein the subscription message includes a first parameter indicating a group of VAL UEs, or all VAL UEs as measurement target VAL UEs; and
transmitting, to the first network function, a notification message for providing the reporting of the transmission quality measurement.

13. The method according to claim 12, wherein the method further comprises: after receiving the subscription message and before transmitting the notification message,
identifying SEALDD connections corresponding to the measurement target VAL UEs to trigger measurement;
wherein the first parameter comprises a group identifier (ID) of the group of VAL UEs, or an indication to indicate all the VAL UEs;
wherein the group of VAL UEs includes a plurality of VAL UEs sharing the same VAL service and/or being located in the same geographic area;
wherein the subscription message further includes a second parameter indicating a reporting periodicity if the reporting is set to a periodic reporting; and/or
wherein the subscription message further includes a third parameter indicating a reporting granularity; wherein the reporting granularity indicates whether the requested reporting is for a specific VAL UE, an individual VAL UE of multiple VAL UEs, the group of VAL UEs, or all the VAL UEs.

14-17. (canceled)

18. The method according to claim 12, wherein the subscription message further includes a fourth parameter indicating one or more measurement conditions for the transmission quality measurement.

19. The method according to claim 18, wherein the one or more measurement conditions include one or more spatial conditions and/or one or more temporal conditions; and/or
wherein if the one or more conditions are not satisfied, the SEALDD server stops or suspends the transmission quality measurement.

20. The method according to claim 12, further comprising:
for each of the group of VAL UEs or all the VAL UEs:
performing the transmission quality measurement to obtain one or more measurement values; and
generating one or more transmission quality measurement reports, based on the one or more measurement values.

21. The method according to claim 20, further comprising:
aggregating the one or more transmission quality measurement reports, to form an aggregated transmission quality measurement report.

22. The method according to claim 12, wherein the notification message further includes a fifth parameter indicating one or more VAL UEs for which transmission quality are measured and/or reporting of the transmission quality measurements are provided based on the third parameter.

23. The method according to claim 22, wherein if the third parameter is set to a specific VAL UE or an individual VAL UE of multiple VAL UEs, the transmission quality measurement for the one or more VAL UEs is a transmission quality measurement value for the specific VAL UE or the individual VAL UE; and if the third parameter is set to multiple VAL UEs, the transmission quality measurement for the one or more VAL UEs is an aggregation of transmission quality measurement values for the group of VAL UEs or all the VAL UEs.

24. The method according to claim 12, wherein the notification message further includes a sixth parameter indicating an average measurement value of a plurality of transmission quality measurement values for the group of VAL UEs or all the VAL UEs; and/or
wherein the subscription message is a SEALDD enabled data transmission quality measurement subscription request; wherein the notification message is a SEALDD enabled data transmission quality measurement notification; and/or wherein the transmission quality measurement is a measurement on any one of latency, bitrate, or packet loss rate.

25. (canceled)

26. A first network function implementing a Vertical Application Layer (VAL) server, comprising:
at least one processor; and
a non-transitory computer readable medium coupled to the at least one processor, the non-transitory computer readable medium contains instructions executable by the at least one processor, whereby the at least one processor is configured to:
transmit, to a second network function implementing a Service Enabler Architecture Layer (SEAL) Data Delivery (DD) server, a subscription message for requesting a reporting of a transmission quality measurement for one or more VAL User Equipments (UE), wherein the subscription message includes a first parameter indicating a group of VAL UEs, or all VAL UEs as measurement target VAL UEs; and
receiving, from the second network function, a notification message for providing the reporting of the transmission quality measurement.

27. A second network function implementing a Service Enabler Architecture Layer (SEAL) Data Delivery (DD) server, comprising:
at least one processor; and
a non-transitory computer readable medium coupled to the at least one processor, the non-transitory computer readable medium contains instructions executable by the at least one processor, whereby the at least one processor is configured to:
receive, from a first network function implementing a Vertical Application Layer (VAL) server, a subscription message for requesting a reporting of a transmission quality measurement for one or more VAL User Equipments (UE), wherein the subscription message includes a first parameter indicating a group of VAL UEs, or all VAL UEs as measurement target VAL UEs; and
transmit, to the first network function, a notification message for providing the reporting of the transmission quality measurement.

28-29. (canceled)

30. The first network function according to claim 26, wherein the first parameter comprises a group identifier (ID) of the group of VAL UEs, or an indication to indicate all the VAL UEs;
wherein the group of VAL UEs includes a plurality of VAL UEs sharing the same VAL service and/or being located in the same geographic area;
wherein the subscription message further includes a second parameter indicating a reporting periodicity if the reporting is set to a periodic reporting; and/or
wherein the subscription message further includes a third parameter indicating a reporting granularity; wherein the reporting granularity indicates whether the requested reporting is for a specific VAL UE, an individual VAL UE of multiple VAL UEs, the group of VAL UEs, or all the VAL UEs.

31. The second network function according to claim 27,
wherein the at least one processor is further configured to: after receiving the subscription message and before transmitting the notification message, identify SEALDD connections corresponding to the measurement target VAL UEs to trigger measurement;
wherein the first parameter comprises a group identifier (ID) of the group of VAL UEs, or an indication to indicate all the VAL UEs;
wherein the group of VAL UEs includes a plurality of VAL UEs sharing the same VAL service and/or being located in the same geographic area;
wherein the subscription message further includes a second parameter indicating a reporting periodicity if the reporting is set to a periodic reporting; and/or
wherein the subscription message further includes a third parameter indicating a reporting granularity; wherein the reporting granularity indicates whether the requested reporting is for a specific VAL UE, an individual VAL UE of multiple VAL UEs, the group of VAL UEs, or all the VAL UEs.
